(19) United States
(12) Patent Application Publication
(10) Pub. No.: US 2025/0123907 A1
(43) Pub. Date: Apr. 17, 2025

(54) PROCESSING OF EVENTS OF SYSTEM OF RECORDS

(71) Applicant: DevRev, Inc., Palo Alto, CA (US)

(72) Inventors: Brian Byrne, Issaquah, WA (US); Rabi Shanker Guha, Bengaluru (IN); Bhavani Kumar Hari, Sunnyvale, CA (US)

(73) Assignee: DevRev, Inc., Palo Alto, CA (US)

(21) Appl. No.: 18/488,822

(22) Filed: Oct. 17, 2023

(51) Int. Cl. G06F 9/54

(52) U.S. Cl. CPC G06F 9/542

(57) ABSTRACT

Techniques for propagation of events are described. A system for propagation of events includes a controller, a service, and a publisher-subscriber (pub-sub) unit. The controller may route a request for modification of an object to a service. The modification of the object generates an event and the object corresponds to data in a system of record. The service corresponds to the event generated. The service processes the request for the modification of the object and transmit the event at least one of: directly or indirectly to a publisher-subscriber (pub-sub) unit. The pub-sub unit publishes the received event through the controller to a plurality of receivers. The plurality of receivers corresponds to receivers that are interested about the event.

### BACKGROUND

Generally, many companies or organizations develop products, such as applications, for various purposes. For instance, a company may develop an application for providing end-to-end messaging services for enabling communication through messaging between two or more people. In some cases, the same and/or different companies or organizations may provide services. Particularly, one or more units within the companies or organizations or different companies or organizations may provide services, such as solutions to problems faced by users of the application using customer-relationship management tools, handling customer sales using billing systems, and the like. Each of the product development or services produces a stream of events that describe some activity or change thereof. The events are unique to each system, such as a product development system or a service system. The events may reference one or more entities that span across the systems.

### BRIEF DESCRIPTION OF DRAWINGS

The detailed description is provided with reference to the accompanying figures. In the figures, the leftmost digit(s) of a reference number identifies the figure in which the reference number first appears. The same numbers are used throughout the drawings to reference like features and components.

FIG. 1 illustrates a system to process and integrate data and events from disparate ecosystems pertaining to products or services, according to an example implementation of the present subject matter;

FIG. 2 illustrates a concept of an event funnel, sources, and stages as an object may progress through a system, according to an example implementation of the present subject matter;

FIG. 3 shows a high-level flowchart for processing actions, according to an example implementation of the present subject matter;

FIG. 4 illustrates a block diagram of a system for propagation of events of a system of record, according to an example implementation of the present subject matter;

FIG. 5 illustrates a method for processing of events of a system of record, according to an example implementation of the present subject matter;

FIG. 6 illustrates a method for processing of events of system of record, according to an example implementation of the present subject matter;

FIG. 7 illustrates a method for processing of events of system of record at a controller, according to an example implementation of the present subject matter;

FIG. 8 illustrates a method for propagation of events of system of record, according to an example implementation of the present subject matter; and

FIG. 9 illustrates a computing environment, implementing a non-transitory computer-readable medium for propagation of events of system of record, according to an example implementation of the present subject matter.

Throughout the drawings, identical reference numbers designate similar elements, but may not designate identical elements. The figures are not necessarily to scale, and the size of some parts may be exaggerated to illustrate the example shown with better clarity. Moreover, the drawings provide examples and/or implementations consistent with the description; however, the description is not limited to the examples and/or implementations provided in the drawings.

### DETAILED DESCRIPTION

A system of record includes events that are related to product development ecosystems, services ecosystems, or the like. Particularly, the system of record includes a high volume of events. For instance, the system of record may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like. In this regard, when an update to an object is made, an event is generated. The event may have to be disseminated reliably to the appropriate clients that are interested in the objects and also in real time. For example, assume that a user of an application raises a ticket of highest priority to flag an issue with the application. Further, assume that a developer has to address the issue with the highest priority. In this regard, when the user raises the ticket, the developer must receive the alert to notify that the ticket's priority has been raised. This must be done reliably and also in real time to minimize any delay in fixing the issue and to reduce any latency.

Generally, in conventional scenarios, there is a delay in event processing, thereby making such conventional systems to have high-latency and/or have inefficiencies. In this regard, if there are a large number of objects and events, a system with an event pipeline that gathers and delivers events in real time quickly and efficiently may have to be provided.

The present subject matter provides systems and methods for processing of events of a system of record. The present subject matter provides techniques with an event pipeline that gathers and delivers the events quickly and efficiently in real time.

In an example, a system for propagation of events may include a controller, a service, and a publisher-subscriber (pub-sub) unit. A user may make an update to objects corresponding to data in a system of record, such as changes to the object, addition of an object, deletion of an object, and the like. The system of record may include events or objects, such as to track work about a product of a company, various operations being performed within a company, to track issues on an application developed using development tools, to track bugs in the application developed, to track interactions with users of product of companies, to track tickets raised by users, to track sales leads, potential customers, and the like. In this regard, when an update is made to the object, an event may be generated. The event may be included in the system of record. The controller may route a request for modification of the object to the service. For instance, assume that a user has changed a priority of a ticket regarding an issue in an application. Accordingly, such a change to a ticket may generate an event. The service may correspond to the event generated. For instance, assume that a user has changed a priority of a ticket to a lowest priority (for example, P4) to a highest priority (for example, P1) regarding an issue in an application. A developer-entity system service may receive the change in priority and may update database corresponding to developer data. The service may process the request for modification of the object and then transmit the event generated to the pub-sub unit. In one example, the service may indirectly transmit the event generated to the pub-sub unit. However, in some scenarios, faster transmission of events may be required. Accordingly, in another example, the event may transmit the event generated directly to the pub-sub unit.

In an example, to indirectly transmit the event, the system for propagation of events may include a data repository, a Change Data Capture (CDC) log, and a back-end consumer. The repository may correspond to the service. For instance, if the service is a developer entity/system service, the data repository may be a collection of records corresponding to developer data. In such an example, the data repository may include data, such as services subscribed by existing customers, contact details corresponding to existing customers, details corresponding to potential future customers.

The CDC log may capture generation of the event. For instance, the CDC log may capture change in the priority of the ticket to the lowest priority (for example, P4) to the highest priority (for example, P1) regarding the issue in the application. The back-end consumer may analyze and classify the event. For instance, the back-end consumer may analyze the event generated in the CDC log and classify the event as a change in priority relating to the ticket regarding the application in the ticket. The analysis and classification may enable notifying subscribers of the corresponding event.

Further, to indirectly transmit the event, the service may apply the modification to the data repository. Particularly, the service may apply the modification to the data corresponding to the event in the data repository. The back-end consumer may analyze the CDC log and classify the event and transmit the event to the pub-sub unit.

In an example, the service may not be able to publish the event to the pub-sub unit directly due to various reasons, such as crashing of the service, and the like. In this regard, if the event is not published to the pub-sub unit, the event may not reach a plurality of receivers through the controller. Accordingly, the transmission of the event to the plurality of receivers may be missed. Therefore, in an example, to directly transmit the event to the pub-sub unit, the service may apply the modification to the data repository. Further, the service may await receiving a confirmation from the data repository regarding the application of the modification. Subsequently, the service may transmit the event directly to the pub-sub unit in response to a receipt of the confirmation from the data repository regarding the applying of the modification.

In an example, the event may be transmitted to the pub-sub unit on a channel having an identifier corresponding to the object. In an example, the plurality of receivers may subscribe to the channel corresponding to the identifier of the object. The controller may determine the plurality of receivers from a first set of receivers. The first set of receivers may correspond to receivers with a connection established to the controller. Accordingly, the determination of the plurality of receivers may be based on a subscription of a channel of the pub-sub unit corresponding to the identifier of the object by the plurality of receivers. For instance, to start the processing of events, a first set of receivers may connect using a web browser or an application. During the lifetime of connection of each of the first set of receivers (e.g. the duration a web browser remains on a website or an application is running), the first set of receivers may want to receive one or more of the generated events. In this regard, the plurality of receivers of the first set of receivers may want to receive an event, such as a change in priority of a ticket corresponding to an issue in an application. Accordingly, the plurality of receivers may be subscribed to a channel of the pub-sub unit corresponding to an identifier of the object corresponding to the event. Assume that the object is a user ticket and assume that the user ticket has an identification number. In this regard, the pub-sub unit may have a channel with the identification number of the user ticket. The plurality of receivers may be subscribed to the channel of the pub-sub unit that has the identification number of the user ticket. To receive the event, each of the plurality of receivers may establish a connection with the controller.

In an example, the event may have to be transmitted to each of the plurality of receivers. However, the controller may maintain only one subscription to the pub-sub unit for the channel. Therefore, upon receiving the event from the pub-sub unit, the controller may demultiplex the event and deliver it to each of the plurality of receivers. Accordingly, in an example, the controller may receive the event from the pub-sub unit. Further, the controller may demultiplex the received event into a plurality of streams of the event. Each stream of the plurality of streams of the demultiplexed event may be transmitted to a receiver of the plurality of receivers.

In some scenarios, the service may be able to directly publish the event to the pub-sub unit in addition to sending the event to the database. In such scenarios, at the controller, two instances of the same event may be received to be sent to the plurality of receivers. For example, the first instance of the event may be received from the pub-sub unit that is directly published from the service and the second instance of the event may be received from the pub-sub unit through the data repository, the CDC log, and the back-end consumer. In this regard, to prevent redundancy of the events and to prevent network traffic by sending the same event more than once, the controller may use deduplication before sending to the plurality of receivers.

Therefore, when the event is transmitted directly as well as indirectly to the pub-sub unit, the controller may ascertain if the event is already received and transmitted by the controller. The controller may transmit the event to each of the plurality of receivers upon the ascertaining that the event is not already received and transmitted by the controller. Alternatively, if it is ascertained that the event is already received and transmitted by the controller, then the controller may refrain from transmitting the event to each of the plurality of receivers.

In the present subject matter, the events are transmitted reliably and in real time. The plurality of receivers interested in the events are registered for the events via subscription to channels in the pub-sub unit corresponding to objects. Further, events are sent via two mechanisms to the pub-sub unit. In other words, the events are transmitted to the pub-sub unit indirectly and/or directly. Therefore, the present subject matter ensures that the receivers subscribed to the event receive the notification of the event. Furthermore, at the controller, deduplicating of the events may be performed. Accordingly, the present subject matter eliminates redundancy of the transmission of the events to the plurality of receivers and reduces unnecessary event traffic. Accordingly, the present subject matter leverages the event deduplication, and thereby, allows the services to publish the events to avoid the latency of the CDC log pipeline. The present subject matter ensures multiplexing of the events into several streams and sends the events to the plurality of receivers and thereby, ensuring that each of the subscribed receivers receives the event. Accordingly, in the present subject matter, channel multiplexing is leveraged to reduce unnecessary back-end traffic for the events for the plurality of receivers subscribed to overlapping sets of events. The present subject matter leverages the CDC log to gather all the events in the system without relying on the service to publish them individually. In addition, the present subject matter leverages channels of the pub-sub unit to allow for billions of event channels.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

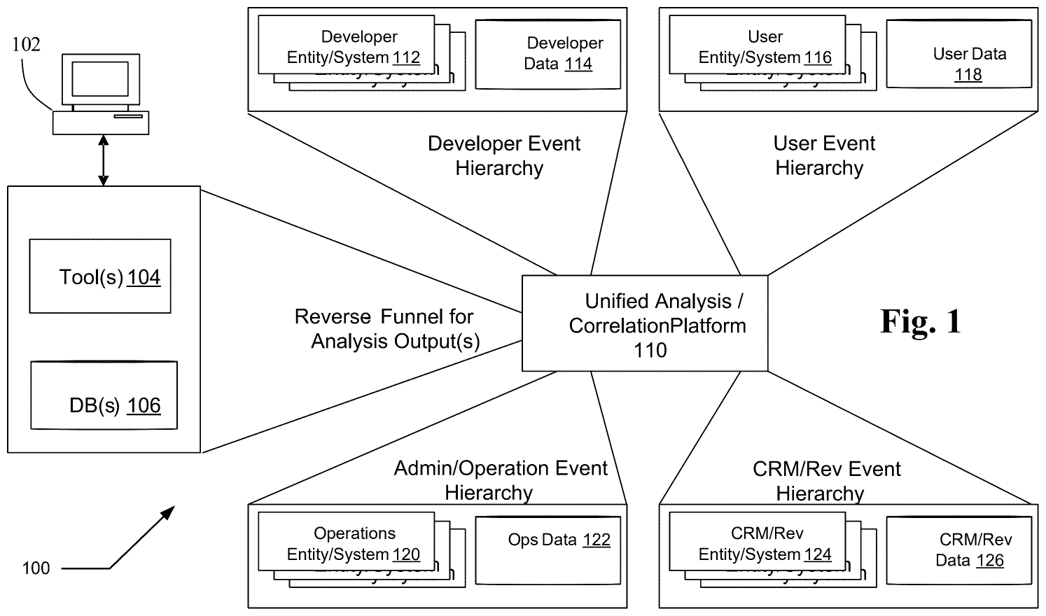

FIG. 1 illustrates a system 100 to process and integrate data and events from disparate ecosystems pertaining to products or services, according to an example implementation of the present subject matter. In systems, such as development of customer relations management (CRM) systems, developers (hereinafter referred to as “Dev”) side are isolated from their users/customers (hereinafter referred to as “Rev”) side. Accordingly, the system 100, by removing barriers between the “Dev” side and the “Rev” side, enables to easily connect code on the Dev side to production issues and user/customer interactions on the Rev side. Accordingly, the system 100 permits software development to no longer have to work across silos of different systems to meaningfully communicate and collaborate with their software users and customers.

The system 100 provides a unified analysis/correlation platform 110 to implement an automated template for autonomous clustering of events into event hierarchies as well as autonomous classification and communication between these hierarchies. The term “event hierarchy” may also be referred to herein as a “funnel”, since the operation of the system 100 involves the funneling of large amounts of events from the different hierarchies for processing by the unified analysis/correlation platform 110.

Any number or type of event hierarchies may be acted upon by embodiments of the present subject matter. For example, the figure illustrates event hierarchies pertaining to developer entity/system 112, user entities/systems 116, CRM/Revenue-based entity/system 124, and admin/operator entity/system 120. The developer entity/system 112 may correspond to developer data 114, the user entity/system 116 may correspond to user data 118, the CRM/Revenue-based entity/system 124 may correspond to CRM/Rev data 126, and the admin/operator entity/system 120 may correspond to Ops (“operations”) data 122.

In some examples, the unified analysis/correlation platform 110 uses machine-learning based techniques to automatically process the data and events from the multiple event hierarchies, and to generate one or more databases 106 comprising both raw data and properly categorized data so that analysis tools 104 can be used to extract useful information and accurate results. In this way, a correlated view of the data can be obtained, despite the fact that the event data may originate from numerous disparate and separated systems, and despite the fact that the collected event data may correspond to an immense amount of information that is collected.

The approach, therefore, allows software and service organizations to focus their efforts on the most important issues in their product and to anticipate and resolve customer problems before they are reported. The present subject matter is applicable to any organization that develops products that are delivered to end customers in a manner such that the events are collected during the development, deployment and usage of the product to monitor the health of the product's ecosystem. This present subject matter outlines an application of the inventive method for the Software-as-a-Service (SaaS) industry, but it is not limited to this industry.

The system 100 may include one or more user stations 102 to operate the unified analysis/correlation platform 110. The one or more user stations 102 and/or the servers that host or operate with the system 100 includes any type of computing device that may be used to implement, operate, or interface with the system. Examples of such devices include workstations, personal computers, mobile devices, servers, hosts, nodes, or remote computing terminals. The user station 102 may include a display device, such as a display monitor, for displaying a user interface to users at the user station 102. The user station 102 may include one or more input devices for the user to provide operational control over the activities of the system 100, such as a mouse or keyboard, to manipulate a pointing object in a graphical user interface to generate user inputs. A database system may be communicatively coupled to a storage apparatus (e.g., a storage subsystem or appliance) over a network. The storage apparatus comprises any storage device that may be employed by the database system to hold storage content.

Embodiments of the present subject matter operate by progressing objects within the system through a series of stages that will “funnel” the data into more meaningful sets of analyzed data as the objects progress through the different stages. The raw data from the various Dev and Rev sources are likely to correspond to an extremely large volume of data, which individually by themselves may not provide enough cross-hierarchy context to be meaningful. That large volume of raw data, when analyzed in a unified way across the different hierarchies, may be used to form increasingly smaller and more meaningful sets of data that can be usefully provided to developers, users, managers, and/or any other party that can benefit from a unified cross-hierarchy look at events and data within the system.

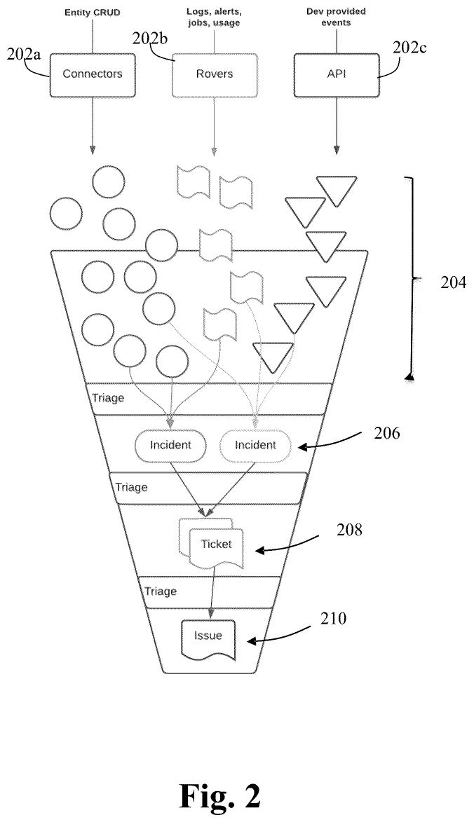

FIG. 2 illustrates the concept of an event funnel, sources, and stages as an object may progress through the system, according to an example implementation of the present subject matter. Within this diagram, events 204 are generated or consumed from multiple event sources. These sources can be acquired using any suitable mechanisms or technique. For example, the events may be acquired using connectors 202a, rovers 202b, and/or using the unified platform's Application Programming Interface (API) 202c.

The connectors 202a may provide bi-directional communications to an entity that provides data. For example, the connectors 202a may be used with respect to entity CRUD operations (“create, read, update, delete” operations). The rovers 202b may be used to implement pure collections activities in a single direction from the Dev or Rev entities, e.g., to collect logs, alerts, jobs, and usage data from an entity. The API 202c may be used to implement programmatic access to event data, e.g., for Dev provided events.

The events 204 then progress through the event funnel where a series of models are applied to cluster and classify the events into items of interest. For example, at a first funneling stage, events of interest (e.g., which are correlated from across multiple event hierarchies) may be clustered into incidents 206. In a subsequent funneling stage, incidents that require human or machine interactions may lead to creation of a ticket 208. Any tickets that are deemed actionable enough may be used to create an issue 210. For example, an issue may be created if a production and/or service change is deemed necessary based upon a ticket.

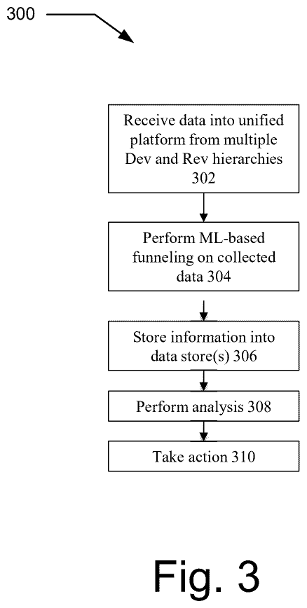

FIG. 3 shows a high-level flowchart 300 for processing actions that are implemented according to some embodiments of the present subject matter. At step 302, data is received into the unified platform from multiple Rev and Dev hierarchies. As previously noted, any suitable collection mechanism may be used to obtain the data from the different event hierarchies, such as, for example, connectors 202a, rovers 202b, and the API 202c.

At step 304, processing is performed upon collected data. In particular, clustering and classification operations are implemented using the collected event data from across the event hierarchies, such as the connectors 202a, rovers 202b, and the API 202c. These clustering and classification operations are used to implement the Machine Learning (ML)-based funneling process to convert a large set/stream of event data into smaller and smaller sets of incident, ticket, and issue data.

At step 306, the output of the clustering, classification, and/or funneling operations is stored into one or more data store(s) and/or formats. For example, as described in more detail below, the analyzed data may be stored into a search/index store, a bulk store, an object database, and/or an analytics database.

At step 308, analysis may be performed using the collected data. For example, incidents, tickets, and issues that were identified in the preceding steps may be used to analyze and identify the root cause of a customer problem when operating a software problem. At step 310, one or more actions may be taken as a result of performing the analysis upon the data. For example, a dev may implement a correction and/or patch to the software to resolve the identified customer error with the software.

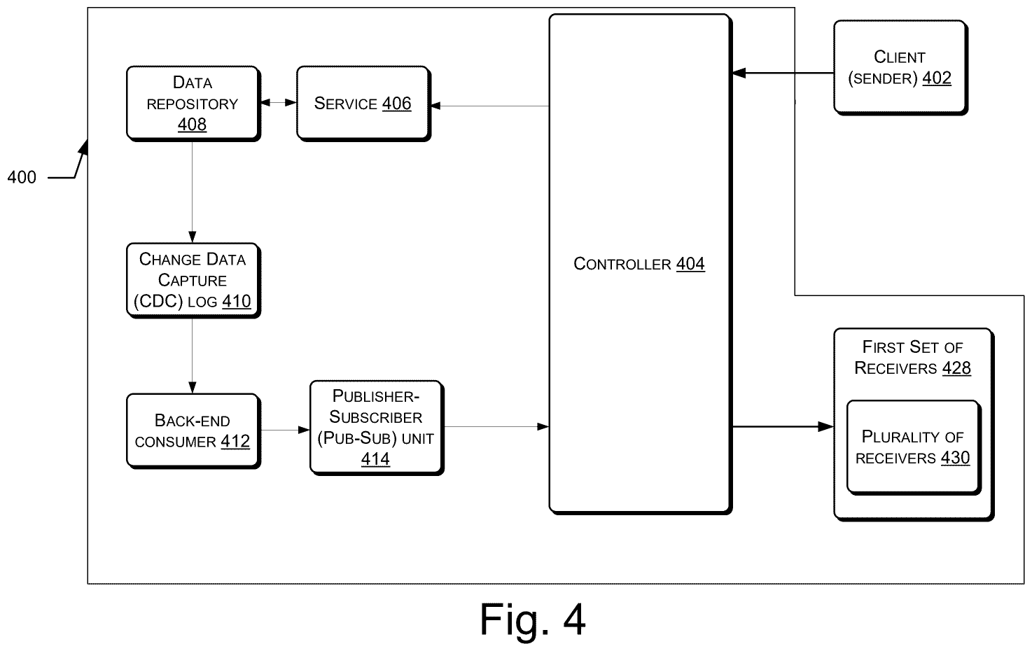

FIG. 4 illustrates a block diagram of a system 400 for propagation of events of a system of record, according to an example implementation of the present subject matter. The system 400 may enable propagation of modification of objects, as will be explained below. In an example, for the propagation of events, the system 400 may include a controller 404, a service 406, and a publisher-subscriber (pub-sub) unit 414.

In an example, a client 402 may connect using a web browser or an application to make changes to an object corresponding to the system of record. Particularly, the client 402 may make an update to objects, such as changes to the object, addition of an object, or deletion of an object, and the like. In this regard, when an update to an object is made, an event may be generated. The event may be included in the system of record. In an example, the system of record may include objects, such as to track work about a product of a company, various operations being performed within a company, track issues on an application developed using development tools, track bugs in the application developed, track interactions with users of product of companies, track tickets raised by users, track sales leads, potential customers, and the like, and the events corresponding to the objects. The client 402 may be referred to as the sender client.

The sender client 402 may correspond to a computing device and may be and/or may include a microprocessor, a microcomputer, a microcontroller, a digital signal processor, a central processing unit, a state machine, a logic circuitry, or a device that manipulates signals based on operational instructions. Among other capabilities, the processing unit may fetch and execute computer-readable instructions stored in a memory, such as a volatile memory or a non-volatile memory, of the sender client 402.

During the lifetime of connection of the sender client 402 (e.g. the duration a web browser remains on a website or an application is running), the sender client 402 may update an object, such as add, make changes to the objects, or remove objects. In this regard, when an update to an object is made to the object, an event may be generated. The event may be included in the system of record.

The sender client 402 may be connected to the controller 404 of the system 400 to make the modification. In this regard, a connection may be established with the controller 404. Particularly, the connection may be established with an instance of the controller 404. For instance, assume that a user (the sender client 402) is using an application and has raised a ticket corresponding to the application to the lowest priority (for example, p4). In this regard, the sender client 402 may want to modify the priority of the ticket from the lowest priority to the highest priority (for example, P1). In this regard, when the sender client 402 may use a website or application to change the priority of the ticket, the connection may be established. The establishing of the connection may enable persistent connection of the sender client 402 till the time the sender client is connected to the application or the website.

The controller 404 may route a request for the modification made to the object to the sender client 402. Further, the generated event may be transmitted to a plurality of receivers 430 through the controller 404, as will be described later. The controller 404 may be and/or may include a microprocessor, a microcomputer, a microcontroller, a digital signal processor, a central processing unit, a state machine, a logic circuitry, or a device that manipulates signals based on operational instructions. Among other capabilities, the processing unit may fetch and execute computer-readable instructions stored in a memory, such as a volatile memory or a non-volatile memory, of the controller 404.

The service 406 may correspond to the event. For instance, assume that a user has changed a priority of a ticket to the lowest priority (for example, P4) to the highest priority (for example, P1) regarding an issue in an application. The developer entity/system 112 may receive the change in priority of the ticket. Accordingly, in an example, the services may correspond to, services, such as developer entity/system 112, user entity/system 116, admin/operator entity/system 120, CRM/Revenue-based entity/system 124, or the like. The services may correspond to computing devices that may be and/or may include a microprocessor, a microcomputer, a microcontroller, a digital signal processor, a central processing unit, a state machine, a logic circuitry, or a device that manipulates signals based on operational instructions. Among other capabilities, the processing unit may fetch and execute computer-readable instructions stored in a memory, such as a volatile memory or a non-volatile memory, of the service.

Each of the services 406 may include a corresponding data repository 408 for storing all the objects corresponding to the service 406. For instance, if the service 406 is a developer entity/system 112, the data repository 408 may be a collection of records corresponding to developer entity/system 112. In such an example, the data repository 408 may include the developer data 114. Accordingly, in an example, the data repository 408 may include developer data 114, user data 118, operations data 122, CRM/Rev data 126, or the like.

The system 400 may include a Change Data Capture (CDC) log 410 and a back-end consumer 412. The CDC log 410 may capture the generation of the event. Particularly, the CDC log 410 may capture incremental changes from the data repository 408 and may put them on a logical queue for further processing using streaming algorithms. The CDC log 410 may create an index for each of the objects in the data repository 408. The indexing of the objects may enable faster retrieval of the objects. As objects are modified, the CDC log may incrementally update the information in the index corresponding to the modified object. Further, the CDC log 410 may archive some or all of the objects in the data repository 408 for long-term storage. As the objects are modified, the updates are propagated to this archive. The CDC log 410 may also allow for enhanced version history which can be used for a variety of use cases including audit history, change invalidation/roll back and the ability to compose a snapshot of the system 400 and/or object at a specific point in time. With these composable snapshots, an object or organization's data may be restored to a specific point in time for troubleshooting or roll back.

The service 406 may include a memory and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The data repository may be provided in the memory. The data repository 408 and the CDC log 410 may be stored in the memory.

The system 400 may include a back-end consumer 412 for analyzing and classification of the event 204, as explained with reference to FIGS. 2 and 3. The back-end consumer 412 may be a computing device, and may be and/or may include a microprocessor, a microcomputer, a microcontroller, a digital signal processor, a central processing unit, a state machine, a logic circuitry, or a device that manipulates signals based on operational instructions. Among other capabilities, the back-end consumer 412 may fetch and execute computer-readable instructions stored in a memory, such as a volatile memory or a non-volatile memory, of the back-end consumer 412.

The publisher-subscriber (pub-sub) unit 414 may publish the received event through the controller 404 to a plurality of receivers 430. The plurality of receivers 430 that are interested about the event. The pub-sub unit 414 may include a plurality of channels. The plurality of receivers 430 interested in the event may subscribe to the corresponding channels. Accordingly, the pub-sub unit 414 may publish the events 204 to the plurality of receivers 430 subscribed to the channel corresponding to the event. In an example, the subscription of the pub-sub unit 414 may be performed through the controller instance.

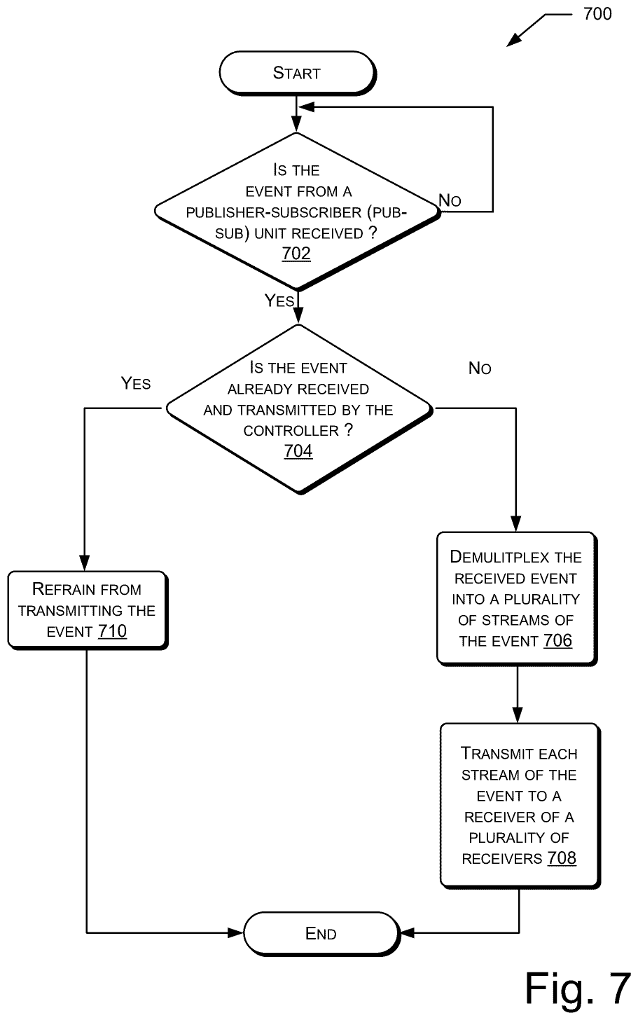

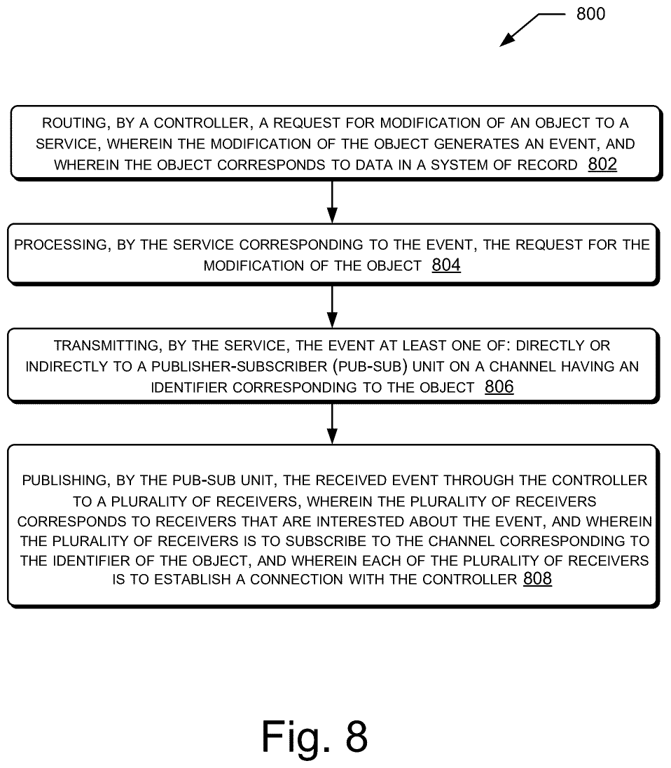

In an example, the system 400 may include a first set of receivers 428 that establish a connection with the controller 404. Among the first set of receivers 428, only the plurality of receivers 430 may be interested to receive about the event generated. Accordingly, the controller 404 may determine the plurality of receivers 430 from the first set of receivers 428 to transmit the event generated, as will be explained with reference to FIGS. 7 and 8.

Each of the first set of receivers 430 may correspond to a computing device and may be and/or may include a microprocessor, a microcomputer, a microcontroller, a digital signal processor, a central processing unit, a state machine, a logic circuitry, or a device that manipulates signals based on operational instructions. Among other capabilities, the processing unit may fetch and execute computer-readable instructions stored in a memory, such as a volatile memory or a non-volatile memory, of the first set of receivers.

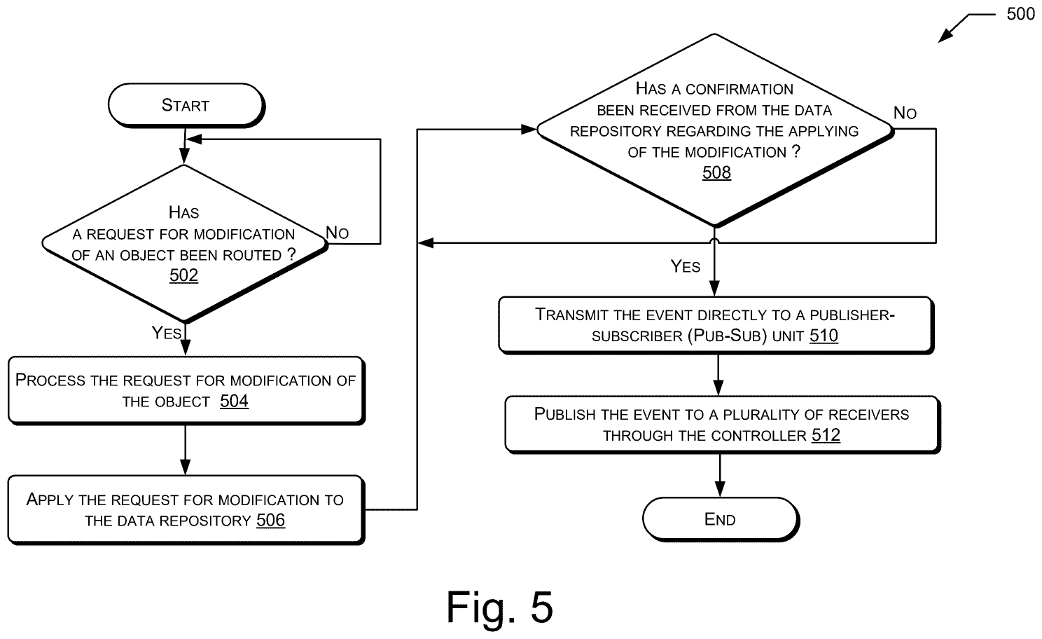

FIG. 5 illustrates a method 500 for processing of events of the system of record, according to an example implementation of the present subject matter. Herein, the method 500 may correspond to direct transmission of the event to the pub-sub unit. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 400.

At step 502, the controller 404 may route a request for modification of an object. In this regard, the sender client 402 may make an update to the objects corresponding to data in the system of record, such as changes to the object, addition of an object, or deletion of an object, and the like. When the update to an object is made to the object, an event may be generated. The event may be included in the system of record. The sender client 402 may be connected to the controller 404 of the system to make the modification. In this regard, a connection may be established with the controller 404. Particularly, the connection may be established with an instance of the controller 404. For instance, assume that a user (the sender client 402) is using an application and has raised a ticket corresponding to the application to the lowest priority (for example, p4). In this regard, the sender client 402 may want to modify the priority of the ticket from the lowest priority to the highest priority (for example, P1). In this regard, when the sender client 402 may use a website or application to change the priority of the ticket, the connection may be established. The establishing of the connection may enable persistent connection of the sender client 402 till the time the sender client 402 is connected to the application or the website.

At step 502, if the request for the modification is routed through the controller 404, then the method 500 may proceed to step 504 and the method 500 may repeat the step 502 till the request for the modification is routed through the controller 404.

At step 504, the request for the modification of the object may be processed. The controller 404 may transmit the request for modification of the object to the service. The service 406 may process the request for modification of the object. The processing of the request for the modification of the object may include determining the object that has been requested for modification and an identifier corresponding to the object.

Subsequently, at step 506, the service 406 may apply the request for the modification to the data repository. For instance, the developer entity/system 112 may change the priority of the ticket from P4 to P1 on the developer data 114.

At step 508, the service 406 may determine whether a confirmation has been received from the data repository 408 regarding the application of the modification to the data repository 408. If the confirmation has been received from the data repository 408 regarding the application of the modification, the method 500 may proceed to step 510. On the other hand, if the confirmation has not been received from the data repository 408, the method 500 may wait until the confirmation has been received and may repeat the step 508.

Then, at step 510, the service 406 may transmit the event directly to the pub-sub unit 414 in response to a receipt of a confirmation from the data repository regarding the application of the modification. In an example, the event may be transmitted to the pub-sub unit 414 on a channel having an identifier corresponding to the object. For instance, upon the modification of the priority of the ticket, the developer data 114 may send a confirmation to the developer entity/system 112 that the priority of the ticket has been changed. Only upon receiving the confirmation from the developer data 114, the developer entity/system 112 may transmit the event to the pub-sub unit 414. On the other hand, if the confirmation is not received from the developer data 114, the developer entity/system 112 may repeat the step 508 and await the confirmation from the developer data 114.

At step 512, the pub-sub unit 414 may publish the event 204 to the plurality of receivers 430 through the controller 404, as will be described in detail with respect to FIG. 7. For instance, the pub-sub unit 414 may publish the event 204 of priority of the ticket 208 being changed from P4 to P1 to the plurality of receivers 430 through the controller 404. The method 500 enables transmission of the events of the plurality of receivers 430 in a faster way and in real time.

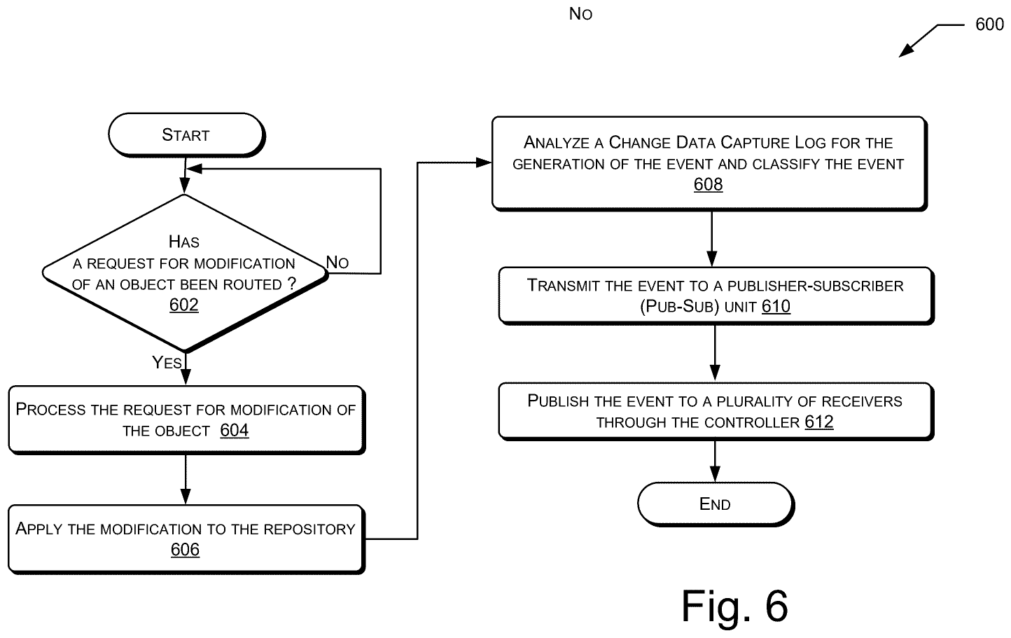

FIG. 6 illustrates a method 600 for processing of events of the system of record, according to an example implementation of the present subject matter. Herein, the method 600 may correspond to indirect transmission of the event to the pub-sub unit 414. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 400.

At step 602, the controller 404 may route a request for modification of an object. In this regard, the sender client 402 may make an update to the objects corresponding to data in the system of record, such as changes to the object, addition of an object, or deletion of an object, and the like. When the update to an object is made to the object, an event may be generated. The event may be included in the system of record. The sender client 402 may be connected to the controller 404 of the system to make the modification. In this regard, a connection may be established with the controller 404. Particularly, the connection may be established with an instance of the controller 404. For instance, assume that a user (the sender client 402) is using an application and has raised a ticket corresponding to the application to the lowest priority (for example, p4). In this regard, the sender client 402 may want to modify the priority of the ticket from the lowest priority to the highest priority (for example, P1). In this regard, when the sender client 402 may use a website or application to change the priority of the ticket, the connection may be established. The establishing of the connection may enable persistent connection of the sender client 402 till the time the sender client 402 is connected to the application or the website.

At step 602, if the request for the modification is routed through the controller 404, then the method 600 may proceed to step 604 and the method 600 may repeat the step 602 till the request for the modification is routed through the controller 404.

At step 604, the request for the modification of the object may be processed. The controller 404 may transmit the request for modification of the object to the service 406. The service 406 may process the request for modification of the object. The processing of the request for the modification of the object may include determining the object that has been requested for modification and an identifier corresponding to the object.

Subsequently, at step 606, the service 406 may apply the request for the modification to the data repository 408. Therefore, the application of the request for the modification may generate the event. For instance, the developer entity/system 112 may change the priority of the ticket from P4 to P1 on the developer data 114 and thereby, causing the generation of the event.

Further, at step 608, the CDC log 410 may be analyzed for the generation of the event and for the classification of the event. In this regard, the CDC log 410 may capture the generation of the event. For instance, the CDC log 410 may capture change of the priority of the ticket to a lowest priority (for example, P4) to the highest priority (for example, P1) regarding the issue in the application. The back-end consumer 412 may analyze the CDC log 410 for the generation of the event and classification of the event. For instance, the back-end consumer 412 may analyze the event generated in the CDC log 410 and classify the event as change in priority relating to the ticket regarding an application in the ticket. The analysis and classification may enable notifying subscribers of the corresponding event. The analysis and the classification may be performed, as explained with reference to FIGS. 2 and 3.

At step 610, the back-end consumer 412 may transmit the event to the pub-sub unit 414. For instance, upon the analysis and the classification of the event, the back-end consumer 412 may transmit the event of change of priority of the ticket from P4 to P1 to the pub-sub unit 414. In an example, the event may be transmitted to the pub-sub unit 414 on a channel having an identifier corresponding to the object.

At step 612, the pub-sub unit 414 may publish the event to the plurality of receivers 430 through the controller 404, as will be described in detail with respect to FIG. 7. For instance, the pub-sub unit 414 may publish the event of priority of the ticket being changed from P4 to P1 to the plurality of receivers 430 through the controller 404. The method 600 enables transmission of the events to the plurality of receivers 430 reliably.

FIG. 7 illustrates a method 700 for processing of events of the system of record, according to an example implementation of the present subject matter. Herein, the method may correspond to processing of the events at the controller 404. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof. It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 400.

At step 702, the controller 404 may determine if the event is received from the pub-sub unit 414. For instance, assume that the priority of the ticket corresponding to an application has been changed from priority P4 to priority P1 and thereby, the event has been generated. The event may be received from the pub-sub unit 414. In an example, the event may be received by the pub-sub unit 414 either directly from the service 406, as explained with reference to FIG. 5, or indirectly from the service 406, as explained with reference to FIG. 6. The event received by the pub-sub unit 414 is transmitted to the controller 404.

At step 702, if the event has been received from the pub-sub unit 414, the method may proceed to step 704. On the other hand, if the event has not been received from the pub-sub unit 414, the method may repeat the step 702. At step 704, the controller 404 may ascertain if the event is already received by the controller 404 and transmitted by the controller 404. The controller 404 may transmit the event to each of the plurality of receivers 430 upon the ascertaining that the event is not already received and transmitted by the controller 404. In this regard, the method may proceed to step 706.

At step 706, to transmit the event to the plurality of receivers 430, the controller 404 may demultiplex the received event into a plurality of streams of the event. At step 708, the controller 404 may transmit each stream of the plurality of streams of the demultiplexed event to a receiver of the plurality of receivers 430.

In an example, the plurality of receivers 430 may subscribe to the channel corresponding to the identifier of the object to receive each stream of the event. The controller 404 may determine the plurality of receivers 430 from the first set of receivers 428. The first set of receivers 428 may correspond to receivers with a connection, such as a websocket connection, established to the controller 404.

Accordingly, the determination of the plurality of receivers 430 may be based on a subscription of a channel of the pub-sub unit 414 corresponding to an identifier of the object by the plurality of receivers 430. For instance, to start the processing of the events, the first set of receivers 428 may connect using a web browser or an application. During the lifetime of connection of each of the first set of receivers 428 (e.g. the duration a web browser remains on a website or an application is running), the first set of receivers 428 may want to receive one or more of the generated events. In this regard, the plurality of receivers 430 of the first set of receivers 428 may want to receive an event, such as a change in priority of a ticket corresponding to an issue in an application. Accordingly, the plurality of receivers 430 may be subscribed to a channel of the pub-sub unit 414 corresponding to an identifier of the object corresponding to the event. Assume that the object is a user ticket and assume that the user ticket has an identification number. In this regard, the pub-sub unit 414 may have a channel with the identification number of the user ticket. The plurality of receivers 430 may be subscribed to the channel of the pub-sub unit 414 that has the identification number of the user ticket. To receive the event, each of the plurality of receivers 430 may establish a connection with the controller 404.

On the other hand, if, at step 704, it is ascertained that the event is already received and transmitted by the controller 404, the method may proceed to step 710. At step 710, the controller 404 may refrain from transmitting the event to each of the plurality of receivers 430 upon the ascertaining that the event is already received and transmitted by the controller 404.

Accordingly, the controller 404 of the system deduplicates the event. In other words, the controller 404 ensures only one instance of the event is transmitted to the plurality of receivers 430.

FIG. 8 illustrates a method 800 for propagation of events of the system of record, according to an example implementation of the present subject matter. The order in which the method 800 is described is not intended to be construed as a limitation, and any number of the described method blocks may be combined in any order to implement the method 800, or an alternative method. Furthermore, the method 800 may be implemented by processor(s) or computing device(s) through any suitable hardware, non-transitory machine-readable instructions, or a combination thereof.

It may be understood that steps of the method 800 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 800 may be performed by the system 400.

At step 802, a request for modification of an object may be routed to a service by the controller. The modification of the object generates an event. The object corresponds to the data in a system of record. The service may correspond to the service 406 and the controller may correspond to the controller 404.

At step 804, the request for the modification of the object may be processed by the service corresponding to the event. The processing of the service corresponding to the event may correspond to the processing as explained with reference to FIG. 5 and FIG. 6.

At step 806, the event may be transmitted at least one of: directly or indirectly to a publisher-subscriber (pub-sub) unit by the service. The event may be transmitted to the pub-sub unit on a channel having an identifier corresponding to the object. The pub-sub unit may correspond to the pub-sub unit 414.

At step 808, the received event may be published by the pub-sub unit to a plurality of receivers through the controller. The plurality of receivers may correspond to receivers that are interested about the event. The plurality of receivers may subscribe to the channel corresponding to the identifier of the object. Each of the plurality of receivers may establish a connection with the controller. The plurality of receivers may correspond to the plurality of receivers 430.

In an example, for transmitting the event indirectly to the pub-sub unit, the method 800 includes applying, by the service, the modification to a data repository corresponding to the service. The generation of the event may be captured by the CDC log upon the application of the modification to the data repository. The CDC log may be analyzed by a back-end consumer. The event may be classified by the back-end consumer. The method includes transmitting the event to the pub-sub unit by the back-end consumer. The data repository may correspond to the data repository 408, the CDC log may correspond to the CDC log 410, and the back-end consumer may correspond to the back-end consumer 412.

For directly transmitting the event to the pub-sub unit, the method 800 may include applying, by the controller, the modification to the data repository. The event may be transmitted directly to the pub-sub unit by the controller in response to a receipt of a confirmation from the data repository regarding the application of the modification.

In an example, the method 800 includes determining, by the controller, the plurality of receivers from a first set of receivers. The first set of receivers corresponds to receivers with a connection established to the controller. The first set of receivers may correspond to the first set of receivers 428.

Further, in an example, the method 800 includes receiving, by the controller, the event from the pub-sub unit. The received event may be demultiplexed by the controller. Each stream of the demultiplexed event may be transmitted by the controller to a receiver of the plurality of receivers.

When the event is transmitted directly and indirectly to the pub-sub unit, the method 800 includes ascertaining, by the controller, if the event is already received and transmitted by the controller. The event may be transmitted by the controller to each of the plurality of receivers upon the ascertaining that the event is not already received and transmitted by the controller. Further, the method 800 includes refraining, by the controller, from transmitting the event to each of the plurality of receivers upon the ascertaining that the event is already received and transmitted by the controller.

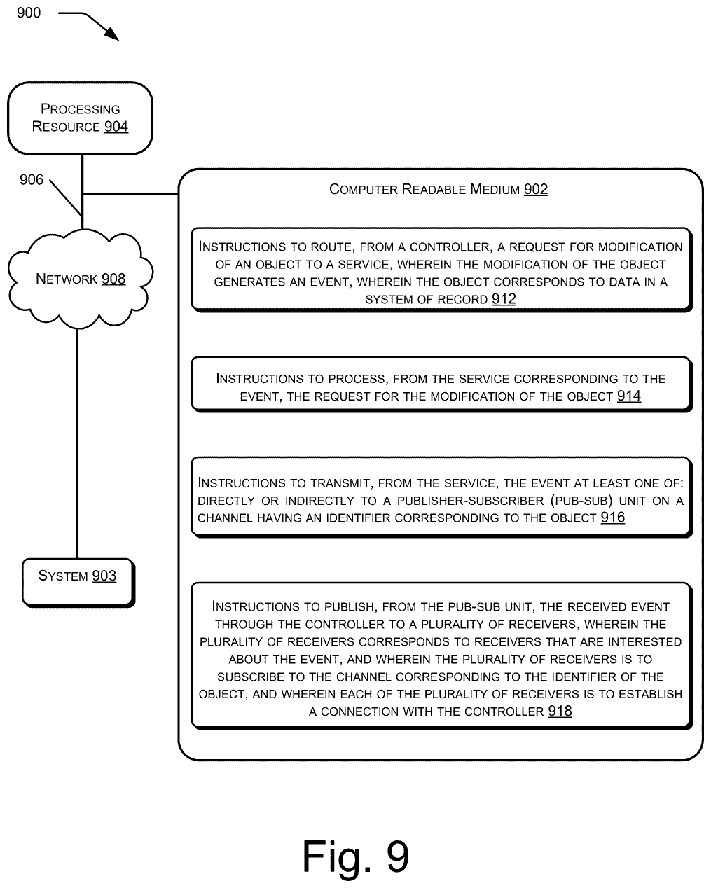

FIG. 9 illustrates a computing environment 900, implementing a non-transitory computer-readable medium for propagation of events, according to an example implementation of the present subject matter.

In an example, the non-transitory computer-readable medium 902 may be utilized by the system 903. The system 903 may correspond to the system 400. The system 903 may be implemented in a public networking environment or a private networking environment. In an example, the computing environment 900 may include a processing resource 904 communicatively coupled to the non-transitory computer-readable medium 902 through a communication link 906.

In an example, the processing resource 904 may be implemented in a device, such as the system 903. The non-transitory computer-readable medium 902 may be, for example, an internal memory device of the system 903 or an external memory device. In an implementation, the communication link 906 may be a direct communication link, such as any memory read/write interface. In another implementation, the communication link 906 may be an indirect communication link, such as a network interface. In such a case, the processing resource 904 may access the non-transitory computer-readable medium 902 through a network 908. The network 908 may be a single network or a combination of multiple networks and may use a variety of different communication protocols. The processing resource 904 and the non-transitory computer-readable medium 902 may also be communicatively coupled to the system 903 over the network 908.

In an example implementation, the non-transitory computer-readable medium 902 includes a set of computer-readable instructions to perform optimized aggregation of a data source. The set of computer-readable instructions can be accessed by the processing resource 904 through the communication link 906 and subsequently executed to perform acts to provide feedback to the actuating object.

Referring to FIG. 9, in an example, the non-transitory computer-readable medium 902 includes instructions 912 to route, from a controller, a request for modification of an object to a service. The modification of the object may generate an event. The object may correspond to the data of a system of record. The controller may correspond to the controller 404 and the service may correspond to the service 406.

The non-transitory computer-readable medium 902 includes instructions 914 to process, from the service corresponding to the event, the request for the modification of the object. The non-transitory computer-readable medium 902 includes instructions 916 to transmit, from the service, the event at least one of: directly or indirectly to a publisher-subscriber (pub-sub) unit on a channel having an identifier corresponding to the object. The pub-sub unit may correspond to the pub-sub unit 414.

The non-transitory computer-readable medium 902 includes instructions 918 to publish, from the pub-sub unit, the received event through the controller to a plurality of receivers. The plurality of receivers may correspond to receivers that are interested about the event. The plurality of receivers may subscribe to the channel corresponding to the identifier of the object. Each of the plurality of receivers may establish a connection with the controller. The plurality of receivers may correspond to the plurality of receivers 430.

In an example, to transmit the event indirectly to the pub-sub unit, the non-transitory computer-readable medium 902 includes instructions to apply, from the service, the modification to a data repository corresponding to the service. The non-transitory computer-readable medium 902 includes instructions to capture, from a CDC log, the generation of the event upon the application of the modification to the data repository and analyze, from a back-end consumer, the CDC log. Further, the non-transitory computer-readable medium 902 includes instructions to classify, from the back-end consumer, the event, and transmit, by the back-end consumer, the event to the pub-sub unit. The back-end consumer may correspond to the back-end consumer 412 and the CDC log may correspond to the CDC log 410. The data repository may correspond to the data repository 408.

In an example, to transmit the event directly to the pub-sub unit, the non-transitory computer-readable medium 902 includes instructions to apply, from the controller, the modification to the data repository. Further, the event may be transmitted from the controller directly to the pub-sub unit in response to a receipt of a confirmation from the data repository regarding the application of the modification.

In an example, when the event is directly and indirectly transmitted to the pub-sub unit, the non-transitory computer-readable medium 902 includes instructions to ascertain, by the controller, if the event is already received and transmitted by the controller. Further, the event may be transmitted by the controller to each of the plurality of receivers upon the ascertaining that the event is not already received and transmitted by the controller. The non-transitory computer-readable medium 902 includes instructions to refrain, by the controller, from transmitting the event to each of the plurality of receivers upon the ascertaining that the event is already received and transmitted by the controller.

In the present subject matter, the events are transmitted reliably and in real time. The plurality of receivers interested in the events are registered for the events via subscription to channels in the pub-sub unit corresponding to objects. Further, events are sent via two mechanisms to the pub-sub unit. In other words, the events are transmitted to the pub-sub unit indirectly and/or directly. Therefore, the present subject matter ensures that the receivers subscribed to the event receive the notification of the event. Furthermore, at the controller, deduplicating of the events may be performed. Accordingly, the present subject matter eliminates redundancy of the transmission of the events to the plurality of receivers and reduces unnecessary event traffic. Accordingly, the present subject matter leverages the event deduplication, and thereby, allows the services to publish the events to avoid the latency of the CDC log pipeline. The present subject matter ensures multiplexing of the events into several streams and sends the events to the plurality of receivers and thereby, ensuring that each of the subscribed receivers receives the event. Accordingly, in the present subject matter, channel multiplexing is leveraged to reduce unnecessary back-end traffic for the events for the plurality of receivers subscribed to overlapping sets of events. The present subject matter leverages the CDC log to gather all the events in the system without relying on the service to publish them individually. In addition, the present subject matter leverages channels of the pub-sub unit to allow for billions of event channels.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for propagation of events, the system comprising:
a controller to route a request for modification of an object to a service, wherein the modification of the object generates an event, wherein the object corresponds to data in a system of record;
the service, wherein the service corresponds to the event generated, wherein the service is to:
process the request for the modification of the object; and
transmit the event at least one of: directly or indirectly to a publisher-subscriber (pub-sub) unit; and
the pub-sub unit to publish received event through the controller to a plurality of receivers, wherein the plurality of receivers corresponds to receivers that are interested about the event.

2. The system of claim 1, comprising:
a data repository corresponding to the service;
a Change Data Capture (CDC) log to capture the generation of the event; and
a back-end consumer to analyze and classify the event,
wherein to indirectly transmit the event through the controller:
the service is to apply the modification to the data repository, and
the back-end consumer is to analyze the CDC log and classify the event and to transmit to the pub-sub unit.

3. The system of claim 2, wherein to directly transmit the event to the pub-sub unit, the service is to:
apply the modification to the data repository; and
transmit the event directly to the pub-sub unit in response to a receipt of a confirmation from the data repository regarding the applying of the modification.

4. The system of claim 1, wherein the event to the pub-sub unit is to be transmitted on a channel having an identifier corresponding to the object.

5. The system of claim 4, wherein the plurality of receivers is to subscribe to the channel corresponding to the identifier of the object.

6. The system of claim 1, wherein the controller is to determine the plurality of receivers from a first set of receivers, wherein the first set of receivers correspond to receivers with a connection established to the controller, wherein the determination is based on a subscription of a channel of the pub-sub unit corresponding to an identifier of the object by the plurality of receivers.

7. The system of claim 1, wherein the controller is to:
receive the event from the pub-sub unit;
demultiplex the received event into a plurality of streams of the event; and
transmit each stream of the plurality of streams of the event to a receiver of the plurality of receivers.

8. The system of claim 1, wherein each of the plurality of receivers is to establish a connection with the controller.

9. The system of claim 1, wherein when the event is transmitted directly and indirectly to the pub-sub unit, the controller is to:
ascertain if the event is already received and transmitted by the controller; and
transmit the event to each of the plurality of receivers upon the ascertaining that the event is not already received and transmitted by the controller.

10. The system of claim 1, wherein when the event is transmitted directly and indirectly to the pub-sub unit, the controller is to:
ascertain if the event is already received and transmitted by the controller; and
refrain from transmitting the event to each of the plurality of receivers upon the ascertaining that the event is already received and transmitted by the controller.

11. A method for propagation of events, the method comprising:
routing, by a controller, a request for modification of an object to a service, wherein the modification of the object generates an event, wherein the object corresponds to data in a system of record;
processing, by the service corresponding to the event, the request for the modification of the object; and
transmitting, by the service, the event at least one of: directly or indirectly to a publisher-subscriber (pub-sub) unit on a channel having an identifier corresponding to the object; and
publishing, by the pub-sub unit, received event through the controller to a plurality of receivers, wherein the plurality of receivers corresponds to receivers that are interested about the event, and wherein the plurality of receivers is to subscribe to the channel corresponding to the identifier of the object, and wherein each of the plurality of receivers is to establish a connection with the controller.

12. The method of claim 11, wherein for transmitting the event indirectly to the pub-sub unit, the method comprises:
applying, by the service, the modification to a data repository corresponding to the service;
capturing, by a CDC log, the generation of the event upon the applying of the modification to the data repository;
analyzing, by a back-end consumer, the CDC log;
classifying, by the back-end consumer, the event; and
transmitting, by the back-end consumer, the event to the pub-sub unit.

13. The method of claim 12, wherein for directly transmitting the event to the pub-sub unit, the method comprises:
applying, by the controller, the modification to the data repository; and
transmitting, by the controller, the event directly to the pub-sub unit in response to a receipt of a confirmation from the data repository regarding the applying of the modification.

14. The method of claim 11, comprising determining, by the controller, the plurality of receivers from a first set of receivers, wherein the first set of receivers corresponds to receivers with a connection established to the controller.

15. The method of claim 11, comprising:
receiving, by the controller, the event from the pub-sub unit;
demultiplexing, by the controller, the received event; and
transmitting, by the controller, each stream of the demultiplexed event to a receiver of the plurality of receivers.

16. The method of claim 11, wherein when the event is transmitted directly and indirectly to the pub-sub unit, the method comprises:
ascertaining, by the controller, if the event is already received and transmitted by the controller;
transmitting, by the controller, the event to each of the plurality of receivers upon the ascertaining that the event is not already received and transmitted by the controller; and
refraining, by the controller, from the transmitting of the event to each of the plurality of receivers upon the ascertaining that the event is already received and transmitted by the controller.

17. A non-transitory computer-readable medium comprising instructions for propagation of events, the instructions being executable by a processing resource to:
route, from a controller, a request for modification of an object to a service, wherein the modification of the object generates an event, wherein the object corresponds to data in a system of record;
process, from the service corresponding to the event, the request for the modification of the object;
transmit, from the service, the event at least one of: directly or indirectly to a publisher-subscriber (pub-sub) unit on a channel having an identifier corresponding to the object; and
publish, from the pub-sub unit, received event through the controller to a plurality of receivers, wherein the plurality of receivers corresponds to receivers that are interested about the event, and wherein the plurality of receivers is to subscribe to the channel corresponding to the identifier of the object, and wherein each of the plurality of receivers is to establish a connection with the controller.

18. The non-transitory computer-readable medium of claim 17, wherein to transmit the event indirectly to the pub-sub unit, the instructions being executable by the processing resource to:
apply, from the service, the modification to a data repository corresponding to the service;
capture, from a CDC log, the generation of the event upon the applying of the modification to the data repository;
analyze, from a back-end consumer, the CDC log;
classify, from the back-end consumer, the event; and
transmit, by the back-end consumer, the event to the pub-sub unit.

19. The non-transitory computer-readable medium of claim 18, wherein to transmit the event directly to the pub-sub unit, the instructions being executable by the processing resource to:
apply, from the controller, the modification to the data repository; and
transmit, from the controller, the event directly to the pub-sub unit in response to a receipt of a confirmation from the data repository regarding the applying of the modification.

20. The non-transitory computer-readable medium of claim 17, wherein when the event is directly and indirectly transmitted to the pub-sub unit, the instructions being executable by the processing resource to
ascertain, by the controller, if the event is already received and transmitted by the controller;
transmit, by the controller, the event to each of the plurality of receivers upon the ascertaining that the event is not already received and transmitted by the controller; and
refrain, by the controller, from transmitting the event to each of the plurality of receivers upon the ascertaining that the event is already received and transmitted by the controller.
